(19) United States
(12) Patent Application Publication
(10) Pub. No.: US 2014/0358849 A1
(43) Pub. Date: Dec. 4, 2014

(54) DATABASE SYSTEM AND METHODS THEREFOR

(71) Applicant: KING.COM LIMITED, St. Julians (MT)

(72) Inventors: Lars Sjodin, Stockholm (SE); Patrik Stymne, Stockholm (SE)

(73) Assignee: KING.COM LIMITED, St. Julians (MT)

(21) Appl. No.: 14/244,305

(22) Filed: Apr. 3, 2014

(30) Foreign Application Priority Data
Apr. 3, 2013 (GB) 1306033.0

(51) Int. Cl. G06F 17/30

(52) U.S. Cl. CPC G06F 17/30289
USPC 707/609; 707/694

(57) ABSTRACT

A control module for controlling data stored in at least one database is disclosed. The control module comprise at least one memory and at least one processor configured to extend the at least one database in accordance with at least one predetermined rule stored in said at least one memory, and populate the records of said extension of said database automatically in dependence on said at least one predetermined rule. The at least one predetermined rule may comprise inserting a null indicator in a record of said extension when no actual data is available.

### CROSS-REFERENCE TO RELATED APPLICATIONS

This application is based on, and claims priority to, Great Britain Application No. GB1306033.0, filed Apr. 3, 2013, the entire contents of which being fully incorporated herein by reference.

### FIELD OF THE INVENTION

Some embodiments may relate to computer game data and other game or user associated data in an online environment. Some embodiments may relate to computer devices connected in a communications network with at least one database storing said data. The computer devices may be configured to selectively communicate with each other over the network. Some embodiments may relate to management and update of the at least one database.

### BACKGROUND OF THE INVENTION

Some computer implemented games may have a very large number of players, each having associated data such as identity (user-name), email, scores, time played, and other associated data which may be provided by the user, for example social network accounts and associated friends therein. Managing such data in databases can present complex infrastructure challenges. This is particularly so when the number of users or players numbers in the tens or hundreds of millions at any one time. Updating user or player data, and mining such “Big Data” is another technical challenge.

Extending a database, by for example adding new fields, typically involves “downtime” in the back-end infrastructure to update the database. Populating the new fields with record data may also involve “downtime”, and in any event the record data for the new field(s) may not be available at the time the database is extended.

### SUMMARY OF THE INVENTION

According to a first aspect, there is provided a method for controlling data stored in at least one database connected to a device, the device having at least one memory and at least one processor configured to extend the at least one database in accordance with at least one predetermined rule stored in said at least one memory, populate the records of said extension of said database automatically in dependence on said at least one predetermined rule.

In an embodiment, the extension of said database may comprise the addition of at least one new field.

In an embodiment, the at least one predetermined rule for automatic population of said records may comprise inserting a null indicator in a record where no record data is available.

In another embodiment, the at least one processor may automatically update said null indicator in a record based on a further rule.

The further rule may comprise monitoring the at least one record in said extended database having a null indicator for an update.

In another embodiment, the monitoring may occur periodically.

In an embodiment, the at least one record in said extended database may be altered or updated in accordance with said further rule.

According to another aspect, there is provided a control module for controlling data stored in at least one database, the control module comprising at least one memory and at least one processor configured to extend the at least one database in accordance with at least one predetermined rule stored in said at least one memory, populate the records of said extension of said database automatically in dependence on said at least one predetermined rule.

In an embodiment the control module may be connected to at least one computing device receiving record data for said database.

In an embodiment the at least one computing device may receive said record data via a connection to at least one server.

In an embodiment, the at least one predetermined rule stored in said at least one memory for automatic population of said records may comprise inserting a null indicator in a record where no record data is received. The null indicator may be a numeric zero “0”, or a null text string “”, or any other suitable null indicator compatible with the database.

In another embodiment, the at least one processor may automatically update said null indicator in a record based on a further rule stored in said at least one memory.

In an embodiment, the further rule may comprise monitoring the at least one record in said extended database having a null indicator for an update.

In another embodiment, there may be a computing device comprising a control module of other embodiments.

In another embodiment, the computing device may be a server.

According to yet another aspect, there is provided a computer program comprising program code instructions which, when executed by a processor of a device connected to, or in communication with at least one database, the device having at least one memory, causes said processor to extend the at least one database in accordance with at least one predetermined rule stored in said at least one memory, and populate the records of said extension of said database automatically in dependence on said at least one predetermined rule.

In yet another aspect, there is provided a computer readable storage device storing program code which, when executed by a processor of a device connected to, or in communication with at least one database, the device having at least one memory, causes said processor to extend the at least one database in accordance with at least one predetermined rule stored in said at least one memory, and populate the records of said extension of said database automatically in dependence on said at least one predetermined rule.

In a further aspect, there is provided controlling means for controlling data stored in at least one database means, the controlling means comprising at least one memory means and at least one processing means, and extending means for extending the at least one database stored in said at least one database means in accordance with at least one predetermined rule stored in said at least one memory means, and population means for populating the records of said extension means of said database means automatically in dependence on said at least one predetermined rule stored in said at least one memory means.

The controlling means may be implemented as hardware based, software based, or a combination of both. The controlling means may be implemented as part of a computing device. The computing device may comprise at least one server receiving record data updates for said database means.

### BRIEF DESCRIPTION OF DRAWINGS

To understand some embodiments, reference will now be made by way of example only to the accompanying drawings, in which:

FIG. 1 shows an example computing device of an embodiment;

FIG. 2 illustrates an example system in which some embodiments may be provided;

FIG. 3 shows a back-end system according to some embodiments;

FIGS. 4A and 4B illustrate tables according to some embodiments; a game according to an embodiment;

FIG. 5 shows an embodiment of a control module according to some embodiments; and

FIG. 6 depicts a flowchart of a method according to an embodiment.

### DETAILED DESCRIPTION OF SOME EMBODIMENTS

The terms user and player are used interchangeably throughout this document and no specific meaning is intended using one or the other unless the context suggests otherwise. A person skilled in the art will realise that the different approaches to implementing the game are not exhaustive, what is described herein are certain preferred embodiments. It is possible to implement the invention in a number of variations without departing from its spirit or scope.

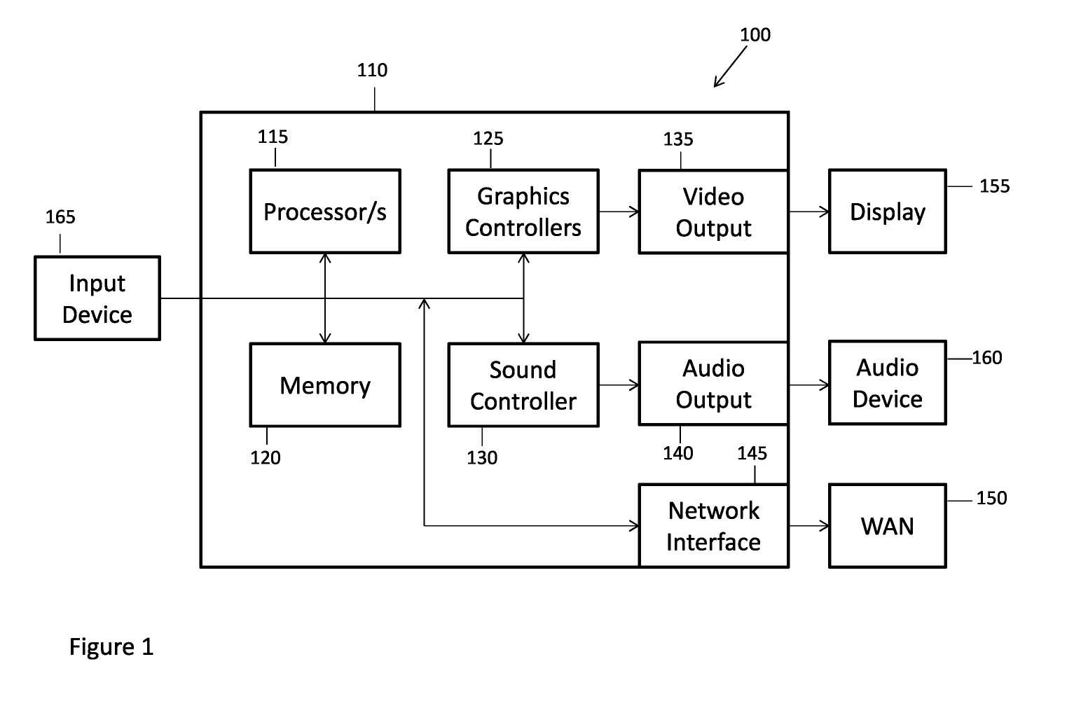

A schematic view of a user device 100 according to an embodiment is shown in FIG. 1. All of the blocks shown are implemented by suitable circuitry. The blocks may be implemented in hardware and/or software. The user device may have a control part 110. The control part 110 has one or more processors 115 and one or more memories 120. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The controller 110 has an interface 145 allowing the device to be able to communicate with a network 150 such as the Internet or other communication infrastructure.

The video output 135 is provided to a display 155. The audio output 140 is provided to an audio device 160 such as a speaker and/or earphone(s).

The device 100 has an input device 165. The input device 165 can take any suitable format and can be one or more of a keyboard, mouse, touch screen, joystick or game controller. It should be appreciated that the display 155 may in some embodiments also provide the input device 165 by way of an integrated touch screen for example.

The blocks of the controller 110 are configured to communicate with each other by an interconnect such as a bus or any other suitable interconnect and/or by point to point communication.

It should be appreciated that in some embodiments, the controller 110 may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

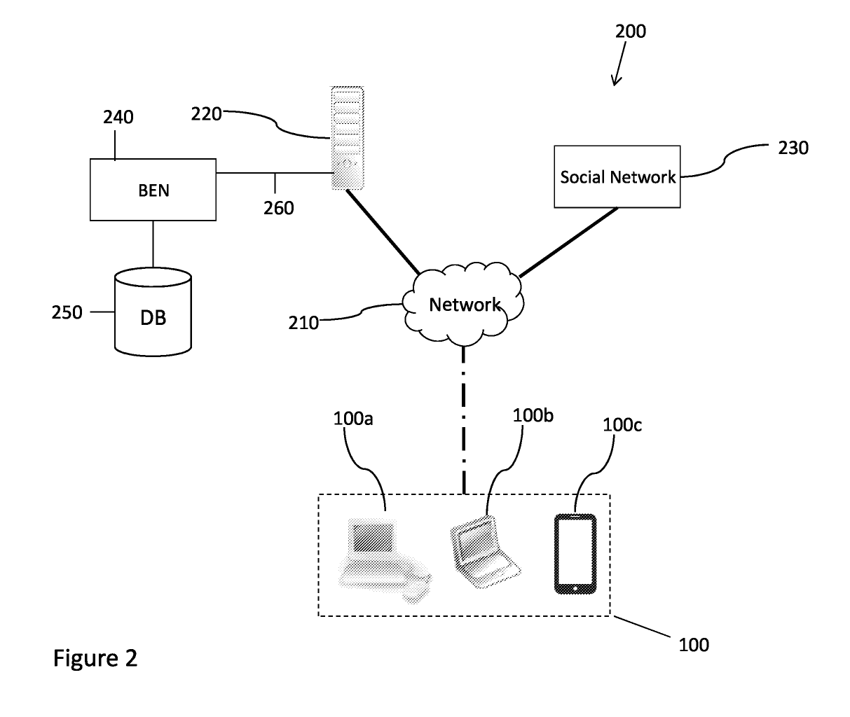

FIG. 2 schematically shows a system 200 in some embodiments. The system 200 comprises a server 220 which may store or be in communication with databases 250 which may be, in some embodiments, connected to a back end infrastructure 240 “BEN”) of game player's details, profiles, statistics, etc. In practice, one or more databases 250 may be provided. Where more than one server 220 is provided, the database(s) 250 may be provided in one database 250 or across two or more servers 220, 310. The server 220 may also have a games data function. This may comprise one or more units of memory to store the computer game program and user behaviour data, and a processor to run the games program and process the user behaviour data.

The server 220 may communicate via for instance the internet 210 to one or more user devices 100, shown in the figure by way of example as user devices 100a, 100b and 100c, and may further provide connections to a social network 230 such as facebook™.

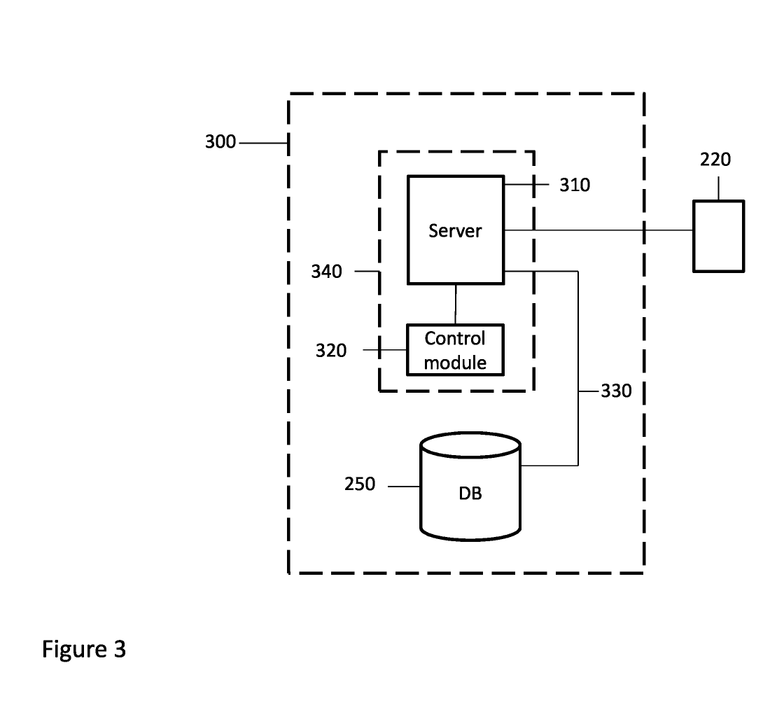

FIG. 3 illustrates a back end infrastructure 300 according to an embodiment, comprising a server 310 in communication with or connected to a control module 320. The control module 320 may be implemented 340 as part of server 310, or may be a separate module 320 external to and connected with the server 310. The server 310 may be one of many servers, such as those known to the person skilled in the art as a server farm 340, or rack

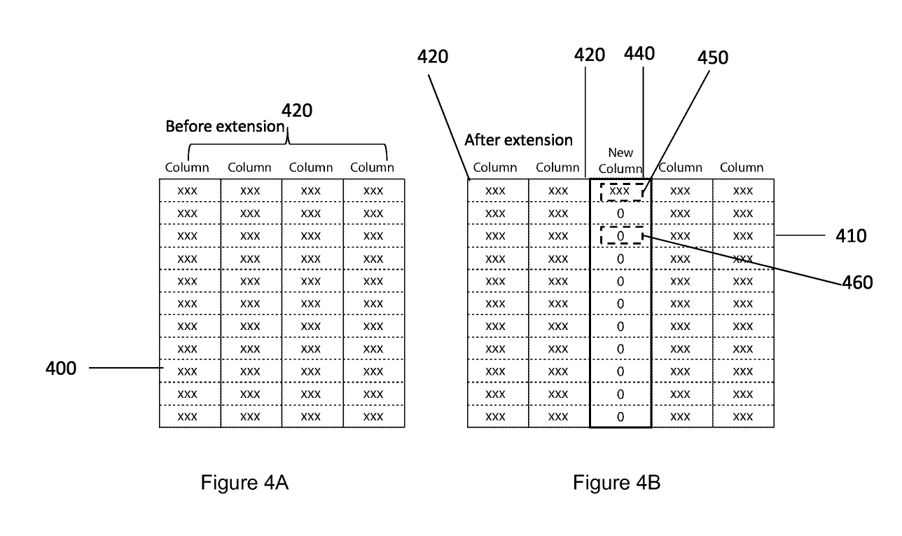

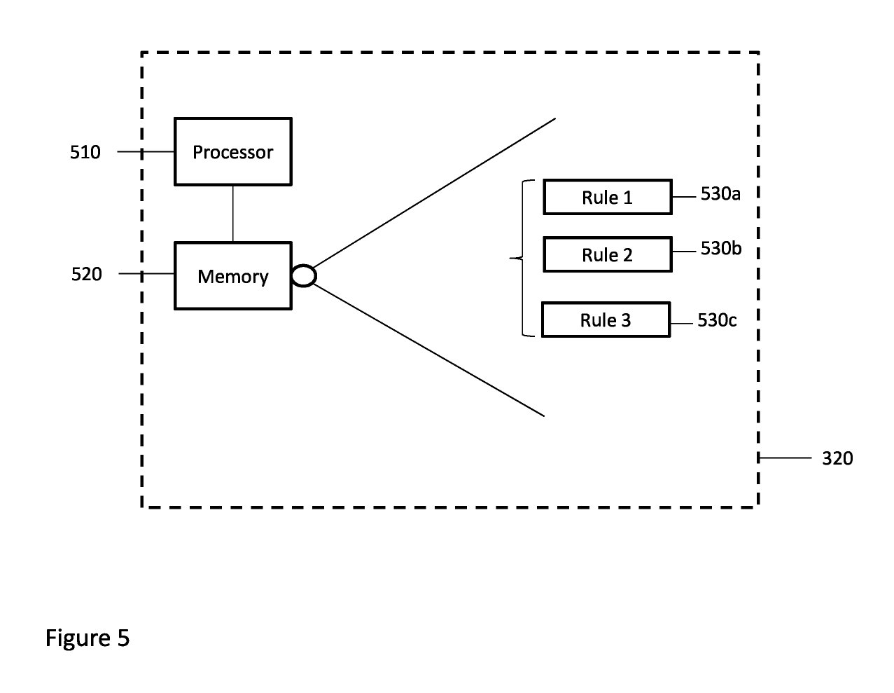

The server 310 or farm 340 may be connected as shown to server 220, and to database 250 via link 330. Link 330 may be wired, wireless and/or provided via or through networks such as the internet, as known to those persons skilled in the art. The control module 320 provides control and update of data in the database(s) 250 as will now be described with reference to FIGS. 4A, 4B and FIG. 5.

FIG. 4A illustrates an example table or array of data stored in database(s) 250. The data is shown as a table or array for ease of understanding, but of course those skilled in the art will realise that other data structures typical of relational databases may be employed, for example multi-dimensional arrays may be utilised. In general, FIG. 4A shows data stored before extension of the database, whilst FIG. 4B shows data stored after extension of the database according to an embodiment.

FIG. 4A shows data 400 arranged in columns or fields 420. The data may comprise user names, associated high score, social network name and so on of players or users accessing and playing the computer implemented game, such as applicants game “Candy Crush Saga”™.

In fact, it is noted that, according to the BBC as of December 2013, “150 billion games of Candy Crush Saga have been played to date. 500 million people have installed Candy Crush” (see http://www.bbc.co.uk/news/magazine-25334716).

Another source, the UK newspaper the Guardian, commented in March 2014 that “93m people are playing Candy Crush Saga more than 1 billion times a day.” (see http://www.theguardian.com/technology/2014/mar/26/candy-crush-saga-king-why-popular).

Hence, these numbers alone have provided severe issues and problems for the applicant or hosts of the applicants' servers and databases, regarding the management, control and updating of such.

Returning now to FIG. 4, FIG. 4B shows an example of a table or array of data stored in a database(s) 250, after extension. FIG. 4B shows a table 400 comprising columns or fields 420, each containing data 400. FIG. 4B also shows the database in an extended mode since new column or field 440 has been added to the database 250. New column or field 440 comprises data where available 450, or no value data 460 as shown in the figure.

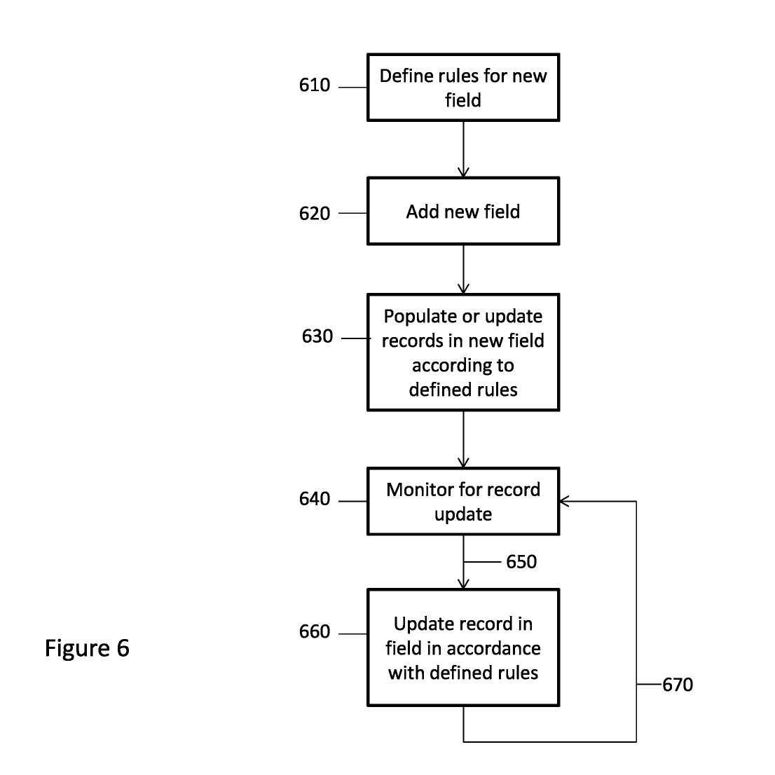

The addition of the new field or column 440 and population of the new column or field 440 will now be described with reference to FIG. 5 and FIG. 6.

FIG. 5 shows, in an embodiment, a control module 320. The control module may comprise at least one processor 510, linked to a memory 520, as shown in the diagram. The at least one memory 520 may store at least one predetermined rule 530a, and at least one further rule 530b. Other rules may be stored in some embodiments 530c.

In an embodiment the control module 320 may be part of a server 310, 220. In an embodiment control module 320 may be a separate computing device forming part of the back end 300.

In an embodiment rule 530a comprises the addition of a field or column 440 extending the database 250. Rule 530b comprises inserting a null indicator into a record 460 of new field 440 when no data exists.

In an embodiment, rule 530c may comprise monitoring database 250 in response to data provided by server 220 for an update to field 460 periodically.

FIG. 6 will now be described which defines a flowchart of an embodiment. At step 610, rules for the new field are defined and stored in memory 520. The rules may be, as in the previous embodiment rule 1, 530a, rule 2, 530b, and rule 3, 530c as previously described. In other embodiments, other rules may be predetermined. Control module 320 may then receive a request to add a new field 440 at step 620. The new field 440 is added to extend the at least one database 250 in accordance with at least one predetermined rule 530a stored in said at least one memory 520. The control module then proceeds to automatically populate or update records 460, 450 in the new field 440 in accordance with the defined rules 530a, 520b, 630c. Once the database 250 has been extended, the process then flows to this step 640 where control module 320, 510 monitors for a record update in the new field. Should an update occur, flow proceeds via path 650 to step 660 wherein an update of the record in the field occurs in accordance with defined rules, for example rule 530b. Control module 320 then returns via path 670 to step 640 to monitor the extended database field 440 for record updates.

In some embodiments, data where available is provided upon extension of the database. For example, data for the new field 440 may be provided 450 upon creation of the new field 440. Should data for a record in the new field not exist, then −a null value indicator or “no value” 460 is inserted to maintain the integrity of the database 250.

In some embodiments the “null value indicator” may comprise the numeral zero. In other embodiments, the null indicator may comprise a null text string, should the field records require text strings or ASCII.

The method described above allows an extension of an already large database 250 with a new field 440 containing or comprising individual records 450, 460, regardless of whether data 460 to fill the records is available at the time of the extension.

This has advantages in that, for relational databases, fields may be added unlinked to other existing fields 420 regardless of whether the actual record data 450 is available at the time of the extension.

The person skilled in the art will realise that the different approaches to implementing the methods and control module are not exhaustive, and what is described herein are certain embodiments. It is possible to implement the above in a number of variations without departing from the spirit or scope of the invention.

1. A method for controlling data stored in at least one database connected to a device, the device having at least one memory and at least one processor configured to:
extend the at least one database in accordance with at least one predetermined rule stored in said at least one memory,
populate the records of said extension of said database automatically in dependence on said at least one predetermined rule.

2. A method according to claim 1, wherein the extension of said database comprises the addition of at least one new field.

3. A method according to claim 1, wherein the at least one predetermined rule for automatic population of said records comprises inserting a null indicator in a record where no record data is available.

4. A method according to claim 3, wherein the at least one processor automatically updates said null indicator in a record based on a further rule.

5. A method according to claim 4, wherein the further rule comprises monitoring the at least one record in said extended database having a null indicator for an update.

6. A method according to claim 5, wherein the at least one record in said extended database is updated in accordance with said further rule.

7. A method according to claim 5, wherein the monitoring occurs periodically.

8. A control module for controlling data stored in at least one database, the control module comprising at least one memory and at least one processor configured to:
extend the at least one database in accordance with at least one predetermined rule stored in said at least one memory,
populate the records of said extension of said database automatically in dependence on said at least one predetermined rule.

9. A control module according to claim 8, wherein the control module is connected to at least one computing device receiving record data for said database.

10. A control module according to claim 9, wherein the at least one computing device receives said record data via a connection to at least one server.

11. A control module according to claim 8, wherein the at least one predetermined rule stored in said at least one memory for automatic population of said records comprises inserting a null indicator in a record where no record data is received.

12. A control module according to claim 11, wherein the at least one processor automatically updates said null indicator in a record based on a further rule stored in said at least one memory.

13. A control module according to claim 12, wherein the further rule comprises monitoring the at least one record in said extended database having a null indicator for an update.

14. A computing device comprising a control module according to claim 8.

15. A computing device according to claim 14, wherein the device is a server.

16. A computer program comprising program code instructions which, when executed by a processor of a device connected to, or in communication with at least one database, the device having at least one memory, causes said processor to:
extend the at least one database in accordance with at least one predetermined rule stored in said at least one memory, and
populate the records of said extension of said database automatically in dependence on said at least one predetermined rule.

17. A computer readable storage device storing program code which, when executed by a processor of a device connected to, or in communication with at least one database, the device having at least one memory, causes said processor to:
extend the at least one database in accordance with at least one predetermined rule stored in said at least one memory, and
populate the records of said extension of said database automatically in dependence on said at least one predetermined rule.

18. Controlling means for controlling data stored in at least one database means, the controlling means comprising at least one memory means and at least one processing means, and extending means for extending the at least one database stored in said at least one database means in accordance with at least one predetermined rule stored in said at least one memory means, and population means for populating the records of said extension means of said database means automatically in dependence on said at least one predetermined rule stored in said at least one memory means.
